(19) United States
(12) Patent Application Publication
(10) Pub. No.: US 2024/0340311 A1
(43) Pub. Date: Oct. 10, 2024

(54) System and Method for Validating Source and Authenticity of Incoming Communications Received by a User Device

(71) Applicant: Lori Lee Mueller, Austin, TX (US)

(72) Inventor: Lori Lee Mueller, Austin, TX (US)

(21) Appl. No.: 18/614,736

(22) Filed: Mar. 24, 2024

Related U.S. Application Data
(60) Provisional application No. 63/494,131, filed on Apr. 4, 2023.

(51) Int. Cl. H04L 9/40

(52) U.S. Cl. CPC H04L 63/1466; H04L 63/12

(57) ABSTRACT

This is a method, a system, and computer-readable medium for verifying a message originator as well as a method for verifying message contents of incoming communications received by an end user device. The verification may be against a previously registered sender and previously registered message. Alternatively, the verification may be against a blacklist of senders. The verification request from the receiver of the incoming message may be automatic or performed by explicit request from the receiver of the message.

### CROSS-REFERENCE TO RELATED APPLICATION

This application claims the benefit of provisional patent application No. 63/494,131 filed Apr. 4, 2023 by the present inventor, which is incorporated by reference in its entirety.

### FEDERALLY SPONSORED RESEARCH

None.

### SEQUENCE LISTING

None.

### TECHNICAL FIELD

This is a method, system, and computer-readable medium to reduce fraud in communication channels and more specifically is a method for authenticating the sender of a message and contents of inbound communications to a user device.

### BACKGROUND

Scammers have crippled outbound communications for almost every business, undermining customer trust and tarnishing business brands. Customers are often afraid to answer their phone or click on links sent to them by a legitimate business, increasing the level of effort required by customers to interact with the business.

Currently, spoofing a legitimate business is an illicit business in itself. Over 68 million Americans reported losing money from phone scams in 2022 up 23% from 2021.

Legitimate businesses have a desire for customers to interact with them, preferably in a self-serve automated fashion. Indeed, the business use of outbound messages continues to increase every year and the business use of chat sessions is expected to also quadruple in the next few years. Meanwhile, prospective customers are unable to know if the source of a call, text, email or chat session is authentic, and may not know if any links in the message are harmful or if the contents of the communication have been modified. There are no reliable solutions for a customer to know or verify that they are talking with an authorized representative of a company trying to communicate with them While some solutions such as U.S. Pat. No. 11,218,590 and US Patent application US20150271327 verify voice callers, there is still a need to provide for end-to-end authentication and verification of outbound business communication, such as with a business chatbot, a business text to an existing customer and other multi-media communication. This solution provides a system and method to increase customer trust for a wide array of growing business communications by verifying sender authenticity as well as message authenticity.

### SUMMARY

This solution provides a reliable out-of-band method and system of authentication for business customers and their employees that confirms business customers are communicating with the party indicated on a call or message as well as confirming that the messages have not been altered in transmission. This solution provides a process for end-to-end authentication of calling or messaging parties and verification of the contents of a message using out-of-band verification. Components of the solution include:

Communication Source Registration Service (CSRS) a. The CSRS is a communications server used by a business to create an account and securely register key communication source identification details such as authorized company display names, outbound calling numbers, domain information used for outbound communications as well as location information such as Internet Protocol addresses, network addresses, and designated administrators. The CSRS may also include key information expected to be found in the message such as one or more Uniform Resource Locators (URLs) or Fully Qualified Domain Names which may be found in the communication of a business. The company may also provide to the CSRS a list of authorized agents for verification at the agent level, including for example, a unique authorization key or biometric information for the authorized agents. This information may include, for example, captured information from a fingerprint, voice, iris or retina of the authorized representative of the business. It is anticipated that biometric information may additionally include DNA verification which may, for example, include verification of the authorized representative's DNA using a third-party service.

### Outbound Communication Registration Service (OCRS)

a. The OCRS is an outbound message registration communication server which stores information about authorized outbound communications for verification by the Incoming Communication Verification Application (ICVA). The OCRS may store verified Business Communication Server (BCS) directory information obtained from the CSRS and provided to the ICVA for direct communication with business-side servers. The OCRS may be collocated with the CSRS, residing on the same server or on a second communication server. The OCRS receives and processes registration for outbound communication from an authorized businesses and processes incoming requests from end user devices for verification here. In some instances, the OCRS may also perform a verification of the ICVA application, such as by comparing identifying details of the ICVA application or details of the end user devices with a list of previously registered ICVA applications or end user devices. The OCRS may call a separate incoming communication look-up service (ICLS) for advanced identification processing.

Business Communication Server (BCS): The BCS is the Local business-side source of outbound communication information. The BCS communicates with the OCRS and ICVA.

Business Communication Verification Server (BCVS): Business-side application for responding to authentication challenge from ICVA. (Note CSRS and OCRS could be combined in one service, but for additional security may be separated.)

Incoming Communication Lookup Service (ICLS): Service used by the OCRS and/or ICVA for advanced processing and data analytics to identify an unrecognized source. The ICLS uses advanced analytics to attempt to validate the business as represented by the message text, caller ID names, user description and domains, including advanced analytic comparison of look-a-like businesses and awareness of scammer behaviors.

Incoming Communication Verification Application (ICVA): The ICVA is an application installed on the end user device, such as with a smartphone application, that communicates securely with a communication server, such as the OCRS, to obtain verification of message originator or verification of the message contents or verification of both the originator and the message contents. In some embodiments, the end user device itself or the ICVA may be additionally verified at the CSRS or at the OCRS. The ICVA may also maintain a local database of known good message originators (whitelist) or known fraudulent originators (blacklist) that is stored locally for faster communications (such as known entities defined or configured by the user).

In one embodiment of this solution, a business registers information about all outbound communications securely with the OCRS, in near real-time. This may include, for example, the IP address, the uniform resource locator of the business, the domain name of the business, or the biometric information of particular agent of the business. In another embodiment, the OCRS may serve as a directory for identification of the authorized business communication server (BCS) or authentication server (BCVS), registered with the CSRS.

The system may be configured to validate communication based on business preferences and the security needed to confirm the source type (voice call, multimedia message, chat, email, etc.). The OCRS may maintain current information about registered companies and their authorized business communication server (BCS) or authentication server (BCVS), registered with the CSRS.

Registration information maintained by the OCRS may depend on the type of communication to be verified and may include communication identifiers such as authorized sender information and receiving party information (e.g. sender name and/or number used for caller id/text display, sending email/domain, sender location, called party number, email, time sent/initiated, and message or a hash of the message if applicable, as well as call status (in progress), or biometric information of the agent of the business. Companies may include agent level identification for additional security.

The application (ICVA) stored on the user device detects an inbound call/message and transmits a query for authentication to the OCRS. Alternatively, this process is manually initiated by the user (alternately called the customer in this application). The OCRS will attempt to match the information displayed to the receiving party with a registered outbound business communication confirming or denying the message originator authenticity as well as the message authenticity indicating that the message was not modified in transit. The ICVA will then receive a query result from the OCRS.

The ICVA application will then display a secure symbol or other message-trusted indicator indicating that the source is verified, or return a proceed with caution indicator. Other indicators may additionally be used to establish level of confidence.

The user side ICVA application can be an independent downloadable application on the device, or integrated into other client software or business applications (phone, email, text/SMS/PC/Browser) and offered by telcos or other third parties.

While the system should be as seamless and automatic as possible for the end user, the ICVA application could also be configured for on-demand authentication. For instance, authentication performed by explicit request after a communication, such as a chat session has begun, or performed when the end user wants to verify a calling party after they have answered a voice call, or when they are asked for sensitive information, or when a text or email includes a link, they are asked to follow. The application can also alert a user when there is a link in a text that doesn't open an already installed application or a link in an email from a domain that is not recognized (or looks like it could be scammer behavior-mismatch between domain name and text, etc.) and the ICVA application may prompt the user to verify the link before clicking the link. The client application can be pre-configured by the user with companies they do regular business with (e.g., their bank, electric company, etc.) for faster confirmation. Advanced analytics will attempt to determine the asserted sender, and if unable to clearly identify a sender company name in the message, the application could ask the user to confirm the business for verification by manually entering the name of the business, by voice, text, or other input mechanism. The application would then check the OCRS to confirm the communication was sent by that business and validate the communication was not altered or return a proceed with caution message.

In one embodiment, a user may pre-configure a list of company names/entities that they do business with (such as banks, specific financial institutions, utility companies, physicians, and the like) and the application will record the OCRS recognized “registered company name” and number for faster matching at the ICVA, but may still validate the outbound communication at the OCRS to ensure it is not being spoofed. User contacts and location may be used to eliminate known non-business callers, thus creating a blacklist, or confirm matches for local businesses and pre-existing business relationships for user convenience.

If no match is made, a message will indicate unverified and the user should proceed with caution—or reach out to the entity directly using a phone number or website that they know to be valid, not necessarily the website or call given to them by the caller. If the business was identified but does not match the sender, the server can return the correct contact information.

Analytics from OCRS services can be used in conjunction with other methods to more quickly identify potential scams and bad actors, prevent fraud, protect brand image, and restore trust in outbound communications.

In various embodiments, additional, fewer, or alternate actions may be included or performed by the system, devices, methods and computer-readable media, including those discussed elsewhere herein.

### BRIEF DESCRIPTION OF THE DRAWINGS

The figures described below depict various aspects of the applications, methods, and systems disclosed herein. Furthermore, wherever possible, the following description refers to the reference numerals included in the following figures, in which features depicted in multiple figures are designated with consistent reference numerals.

FIG. 1 illustrates the initial setup and registration of a business communication server (BCS).

FIG. 2 illustrates the standard verification process of a message sent from a legitimate business.

FIG. 3 illustrates a direct verification with a previously registered BCS.

FIG. 4 illustrates a bad actor attempting a communication with a client device and failed verification by using an OCRS only.

FIG. 5 illustrates a bad actor attempting a communication with a client device and failed verification by using an OCRS registered Business Communication Server (BCS).

FIG. 6 illustrates a ladder diagram of message validation using the OCRS communication server.

FIG. 7 illustrates the components of a client device including the program memory containing the ICVA application within a client device.

### DETAILED DESCRIPTION

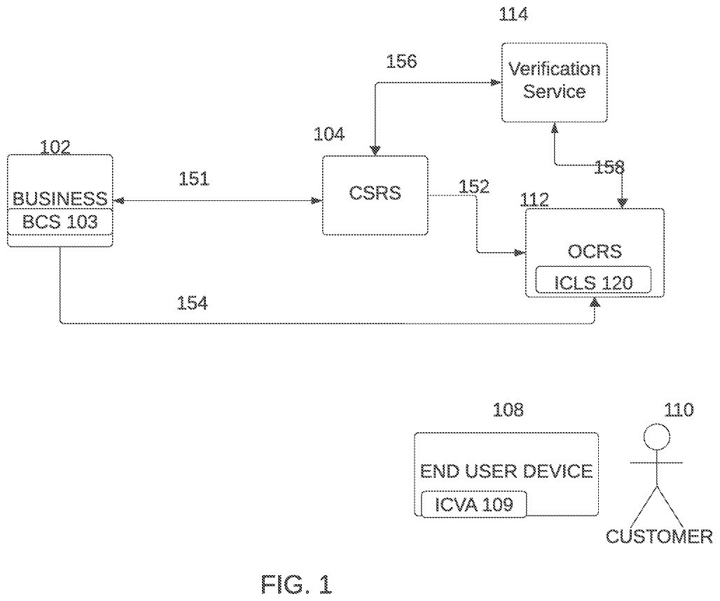

FIG. 1 illustrates the initial setup and initial communication registration of a business communication system. Shown on the diagram is the business communication Server (BCS) 103 associated with a business 102, the Outbound Communications Registration Service (OCRS) 112, the Communication Source Registration Service (CSRS) 104, a third-party verification server 114 connected either to the CSRS 104 or the OCRS 112, the end user device 108, the incoming communication validation application (ICVA) 109 residing on the end user device 108, and the customer 110. The Verification Service 114 may be an electronic or a manual service. The end user device 108 may be a smart phone, or another device such as a feature phone, a tablet or a desktop or a laptop computer. The OCRS 112 may also be, for example, a third-party verification server that verifies multiple businesses as a service. The OCRS 112 may be separate, or co-located with the CSRS 104. As a first step in the registration process, the BCS 103, which may be collocated or at a separate location from the business 102, registers relevant information about the business 102 with the CSRS 104 via link 151. The CSRS 104, in turn, passes the relevant information about the business 102 to the OCRS via link 152. The OCRS 112 may also implement email authentication protocols like SPF, DKIM or DMARC to prevent email spoofing and verify the business digitally. The OCRS 112 may also digitally verify the business with the help of credit card information. In addition, document verification may also be performed as part of a slower registration process and may include requesting official company documents which may include articles of incorporation, business licenses, tax certificates. The CSRS 104 or OCRS 112 may cross reference those documents with government registries or corporate databases. As part of the registration process, Optical Character Recognition (OCR) may be used to extract information from the official documents and verify the document authenticity. Third-party business verification services such as Dun & Bradstreet, Experian, LSEG Data and Analytics or Trulioo Global Gateway may also be used as part of the business verification process.

The information stored on CSRS 104 or OCRS 112 may include personally identifiable information such as names, phone numbers, IP addresses, SIP addresses, email addresses, or other personal information of agents of the business which may be subject to CAN-SPAM and GDPR regulations. For compliance and other reasons, the information stored on CSRS 104 or OCRS 112 may be encrypted in transit and at rest, as well as information sent to the CSRS 104 about the business 102 and BCS 103 such as source IP address, SIP address, Uniform Resource Locators (URL), Fully Qualified Domain Names, calling party numbers, and expected URL or Links associated with the business 102 and message contents expected to be sent by the business 102 may be encrypted. The CSRS 104 then forwards relevant information to the OCRS 112 for registration. The setup on the device side includes the customer 110 downloading an ICVA application 109 onto the end user device 108. The application may be side loaded by the customer from a trusted business webpage, or the application may be located on the Google Play® store or the Apple® App store. The BCS 103 can then begin registering all outbound communications with the OCRS 112 for all messages and contents of messages which may be intended for one or more end user devices 108.

Also shown in FIG. 1 is the ICLS 120 Incoming Communication Lookup Service (ICLS) 120 This service is used by the OCRS and/or ICVA for advanced processing and data analytics to identify an unrecognized source. The ICLS may use advanced analytics to attempt to validate the business as represented by the message text, caller ID names and domains, including advanced analytic comparison of look-a-like businesses and awareness of scammer behaviors

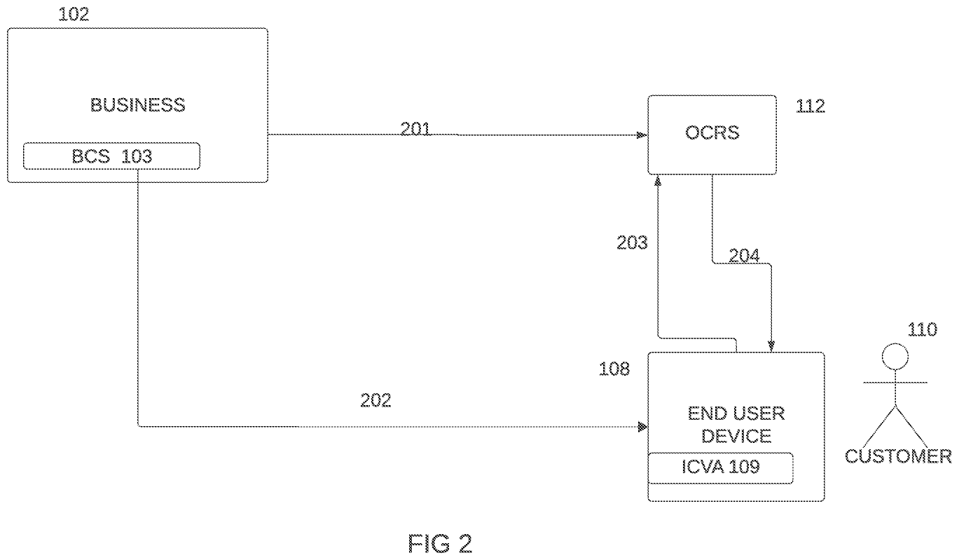

After the registration process shown in FIG. 1, the system is ready for the standard verification method shown in FIG. 2. In FIG. 2, the BCS 103 communicates a legitimate inbound communication to the customers end user device 108. This inbound communication may include a voice call, a multimedia message, an email or a chat session. In this document, a multimedia message includes an SMS text message, an RCS Message, a picture message, a video clip or a combination of text, picture and videoclips. In this method, the message contents may include a Uniform Resource Locator (URL) which may contain the address of a web page, ftp site, audio stream or other Internet resource. After receiving the inbound communication, the ICVA 109 located on the end user device 108 transmits a query to the OCRS 112 requesting a verification of the originator or message authentication from the OCRS 112. The OCRS 112 returns a query result to the ICVA 109 that the communication is verified or not. The ICVA then displays an indicator that the initial communication from the business 102 is verified or, in the negative case, a warning to the customer that caution is advised, or may display some intermediate value indicating the certainty that the message or the message originator is real. The indication may be a word or symbol embedded in the message (such as, for example a shield or a check mark displayed before or adjacent to the message) or the warning may be a separate message saying that the sender as well as contents of the message, such as embedded Uniform Resource Locator (URL) links, have been verified. Alternately a warning indicating the sender of the original message or the contents of the message is not verified. In the case of this example, the previously registered message originator and the expected contents of the message are registered at the OCRS 112, and links and embedded URLs contained in the message are verified to be associated with the business. The message is verified with a query and query result to the end user device 108 which shares the verification to the end user customer 110.

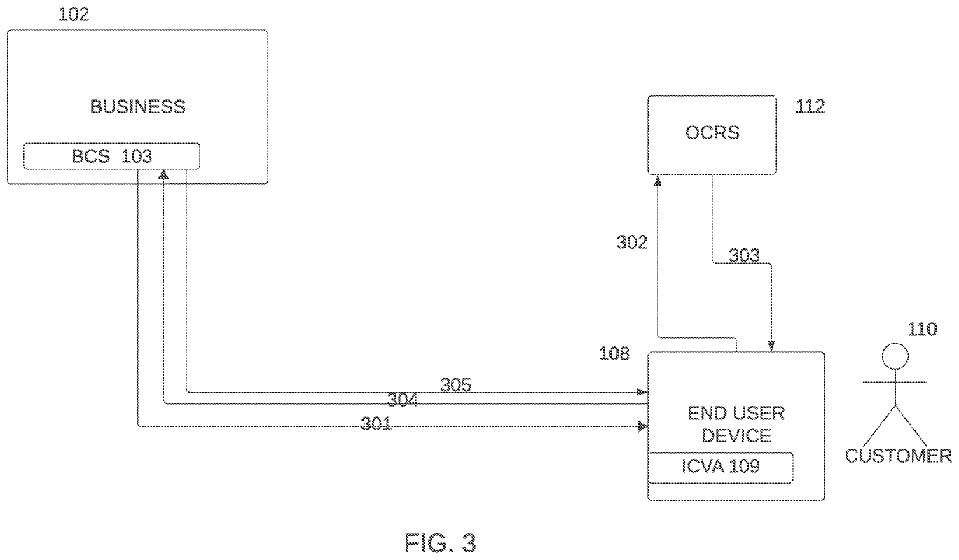

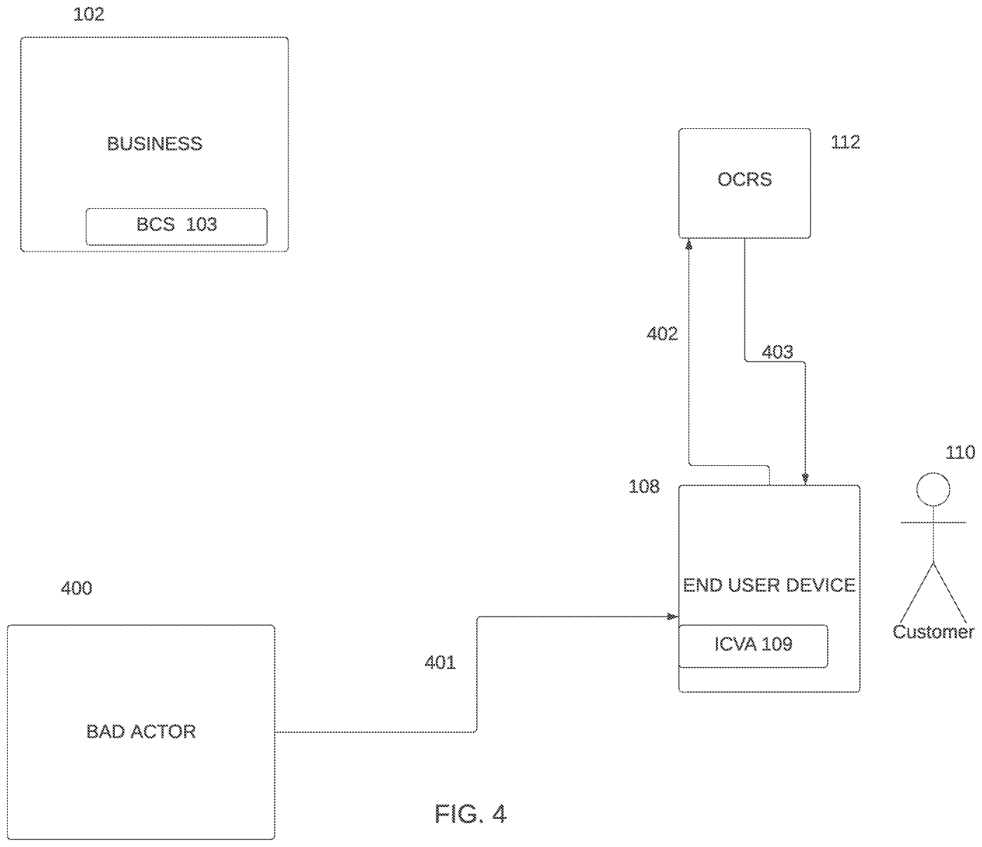

FIG. 3 illustrates a direct verification method with a registered BCS. In this example, a business 102 sends a legitimate communication 301 via the BCS 103 to the end user device 108. The ICVA 109 located on the end user device 108 verifies the BCS 103 address with a query 302 to the OCRS 112. The OCRS 112 may contain, for example a lookup table with addresses of one or more BCS. The OCRS 112 then responds with a returned query result 303 to the ICVA 109, comprising the appropriate BCS address and giving other verification information which may include identification information for the exact representative of the business authorized to send the message and in addition to one or more previously registered valid message originators, may also contain previously registered message contents for each originator. The ICVA 109 then sends a message 304 to the BCS 103 seeking verification of the sender, and optionally, the message contents. The message 304 may include, for example the senders IP address, fully qualified domain name or biometric information of the sender representing the business, such as voice, fingerprint information, retinal information, DNA information and may also include the communication contents itself, such as a link to another address previously associated with the message that the business expects to send out. The BCS 103 sends a message 305 to the ICVA 109 with the results of the verifications of the sender and the contents of the message. The ICVA 109 then displays the verification (or not) to the customer 110. The ICVA 109 may display this verification in a message adjacent to message sent by the business, or the ICVA application may prepend or append the message sent by the business. FIG. 4 illustrates a bad actor attempting a communication with an end user device 108 of a customer 109 and the communication rejected by using an OCRS 112 based on registered sender, and optionally, other information stored at the OCRS 112. In this figure a Bad Actor 400 which is any unauthorized representative of the business, sends a communication 401 to an end user device 108. The ICVA application 109 located on the end user device 108 processes the message 401 and requests verification of the message from the OCRS 112 such as by sending message 402 to the OCRS 112. Message 402 may, for example, containing the IP or other identifying information of the sender 400 and may also, for example contain other information sent in the original communication of 401. When the identifying information of the sender doesn't match the stored records, the OCRS responds with message 403 that no outbound communication has been registered. Upon receiving message 403 from the OCRS 112, the ICVA 109 may immediately issue a warning to the customer 110.

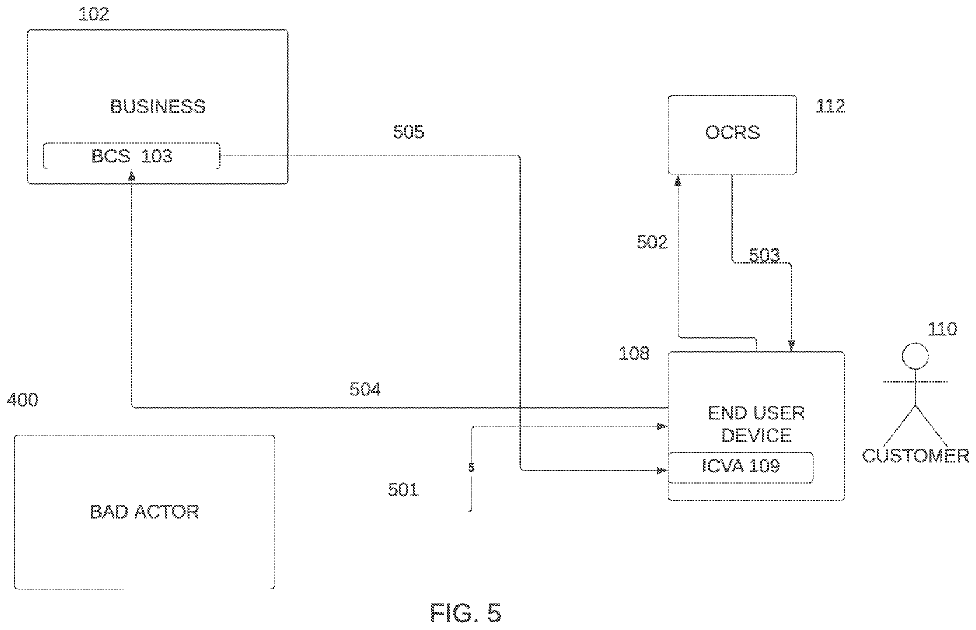

FIG. 5 illustrates a bad actor 400 attempting a communication with an end user device 108 and the communication rejected by using a OCRS registered Business Communication Server (BCS) 103. In this figure, a Bad Actor 400 which is an unauthorized representative of a business, sends a communication 501 to an end user device 108. The ICVA application 109 located on the end user device 108 processes the communication 501 and requests the BCS address, if known, from the OCRS 112 with a message 502 to the OCRS 112. If the BCS Address is undetermined from the communication 501, or unknown to the OCRS 112, the ICVA 109 may immediately issue a warning to the customer 110 via the ICVA 109. If the ICVA 109 is able to determine the particular business being spoofed, the ICVA 109 may request, such as in message 502, the address of the BCS 103, and the ICVA 109 will receive a response message 503 from the OCRS 112 containing the address of BCS 103. The ICVA 109 may then send a message 504 to the BCS 103 to attempt to verify more details of the sender information and may verify the contents of the message 501 with the BCS 103. The sender information may include, for example, the biometric information of the authorized agent of the business which may be verified (or not) by the sender information stored at the OCRS 112 or the BCS 103. If the message 501 is not verified at the OCRS, a non-verification warning is sent in message 505 and the ICVA 109 displays a warning to the customer 110.

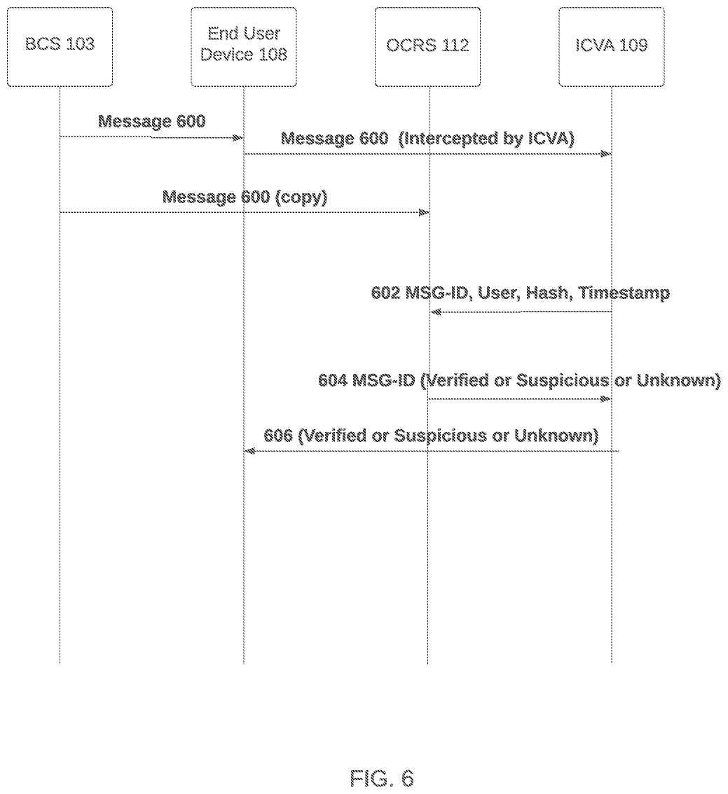

FIG. 6 illustrates a message flow diagram of message validation using the OCRS. In this illustration, a message 600 is sent from the BCS 103 to end user device 108.

At the end user device 108 a previously installed ICVA 109 application intercepts the message 600. On some user devices, this intercept may occur before the display of the message. Either before the message 600 is sent, or just after, an exact copy of the message 600 is sent by the OCS 103 to the OCRS 112. The ICVA 109 then sends message 602 to the OCRS 112 where message 602 contains, in part, message 600 along with additional information. Message 602 may additionally contain a message id, a timestamp and a hash code or checksum of the contents of message 600. The OCRS 112 may then compare the copy of message 600 received from the BCS to message 602 received from the ICVA (comparing hash code, checksum, or another method such as, for example, MD5, RipeMD, HAVAL, Whirlpool, SHA1, SHA2, SHA256, SHA512) and make a determination whether the message received by ICVA and forwarded as part of message 602 is verified, suspicious or unknown. The OCRS 112 communicates the determination of verified, suspicious or unknown to ICVA 109 in message 604. OCRS 112 then communicates its results to end user device 108 in message 606.

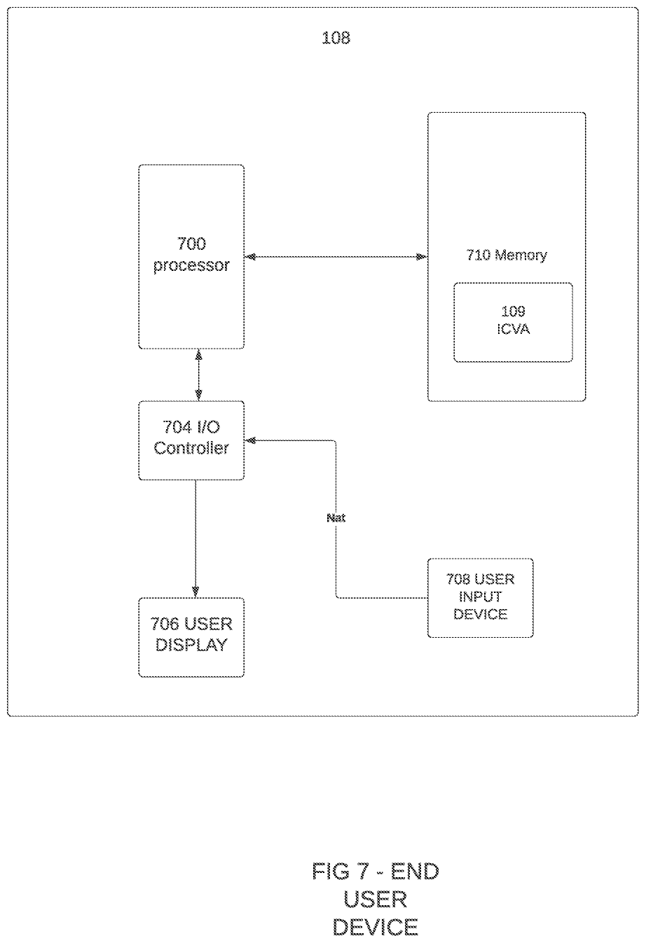

FIG. 7 illustrates the components of a customers end user device 108. Shown are the processor 700, the I/O controller 704, the end user display 706, end user input device 708, memory 710 and ICVA 109 located within memory 710.

The end user device 108 may, for example, be a mobile device, a smartphone, a tablet device, a laptop or a desktop computer. The end user display 706 of FIG. 7 may include a computer monitor or a screen of a mobile device or smartphone. The memory may be RAM, ROM or magnetic media such as a disc, thumb-drive, or a hard-drive or other non-transitory computer-readable medium. The ICVA 109 located within the memory 610 may be, for example a smartphone application that comprises executable program instructions residing on a non-transitory computer-readable medium which cause the processor to execute the steps of this disclosure.

Although individual operations of one or more methods are illustrated and described as separate operations, one or more of the individual operations may be performed concurrently, and nothing requires that the operations be performed in the order illustrated. Structures and components functionality presented as separate components in example configurations may be implemented as a combined structure or component. Similarly, structures and components functionality presented as a single component may be implemented as separate components. These and other variations, modifications, additions, and improvements fall within the scope of the subject matter herein.

As used herein, the term non-transitory machine-readable medium is defined to include any type of machine-readable storage device and/or storage disk and to exclude propagating signals and to exclude transmission media.

This detailed description is to be construed as exemplary only and does not describe every possible embodiment, as describing every possible embodiment would be impractical, if not impossible. One could implement numerous alternate embodiments, using either current technology or technology developed after the filing date of this application. Upon reading this disclosure, those of skill in the art will appreciate still additional alternative structural and functional designs for systems and methods according to the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the techniques disclosed herein without departing from the spirit and scope defined in the appended claims.

1. A method for verifying a message originator and message contents of an incoming communication received by an end user device, comprising: receiving an inbound communication on the end user device; sending a query from the end user device to a communication server in order to authenticate the message originator; and receiving a returned query result from the communication server to the end user device confirming that the message originator is from a registered business.

2. The method of claim 1 wherein the message originator, the message contents, or both the message originator and the message contents contained in the query from the end user device is authenticated on the communication server by comparison to a group comprising one of: a previously registered message, a previously registered message originator, both the previously registered message and the previously registered message originator.

3. The method of claim 2 wherein the previously registered message originator includes biometric information of an authorized agent of the registered business.

4. The method of claim 1 wherein the communication server additionally performs a validation of the incoming communication by comparison to a previously registered message contents, a hash of the previously registered message contents or a combination of the message contents and the hash of the message contents with a communication previously registered at the communication server.

5. The method of claim 4 wherein the inbound communication further includes a Uniform Resource Locator (URL).

6. The method of claim 1 wherein the communication server performs a validation of the inbound communication by comparison to a list of valid message originators.

7. The method of claim 1 that further comprises indicating on the end user device that the incoming communication can be trusted with a message adjacent to the inbound communication.

8. The method of claim 1 that further comprises indicating on the end user device that the incoming communication can be trusted by appending or pre-pending the incoming communication with a message-trusted indicator.

9. The method of claim 1 wherein the inbound communication comprises a voice call.

10. The method of claim 1 wherein the inbound communication comprises a chat session.

11. The method of claim 10 wherein the query to the communication server from the end user device occurs after the chat session has begun.

12. The method of claim 1 wherein the inbound communication comprises a multimedia message.

13. The method of claim 1 wherein the inbound communication includes an email.

14. The method of claim 1 wherein the sending the query to the communication server is performed automatically.

15. The method of claim 1 wherein the sending the query to the communication server is performed by explicit request of an end user from the end user device.

16. The method of claim 1 further comprising verifying the message contents of the incoming communication to the end user device in the returned query result.

17. A system for verifying message authenticity of incoming communications received by an end user device comprising:
a. a communication server which registers an outbound communication from a business;
b. software on the end user device containing a processor and executable program instructions to verify a sender of the incoming communication by communicating with the communication server; and
c. a second communication server which receives a message at a communication from the end user device and transmits an authenticity of the sender of the communication to the end user device.

18. The system of claim 17 wherein the communication server and the second communication server are co-located.

19. A non-transitory computer-readable medium which contains program instructions, that, when executed by a processor, cause the processor to perform:
a. receiving a message by an end user device;
b. sending a query from the end user device to a communication server to verify an authenticity of a message originator;
c. receiving by the end user device, a query result confirming or denying the authenticity of the message originator; and
d. displaying the authenticity of the message originator at the end user device.

20. The non-transitory computer-readable medium of claim 19 further comprising program instructions for displaying the authenticity of message contents to an end user.
